(19) United States
(12) Patent Application Publication
(10) Pub. No.: US 2017/0099789 A1
(43) Pub. Date: Apr. 13, 2017

(54) Systems, Methods, and Devices for Growing and Harvesting Produce

(71) Applicant: Chaz Shelton, Tucson, AZ (US)

(72) Inventor: Chaz Shelton, Tucson, AZ (US)

(21) Appl. No.: 15/290,140

(22) Filed: Oct. 11, 2016

Related U.S. Application Data
(60) Provisional application No. 62/238,854, filed on Oct. 8, 2015.

(51) Int. Cl. A01G 31/02; A01G 31/00; A01G 1/00; A01G 9/14

(52) U.S. Cl. CPC A01G 31/02; A01G 9/14; A01G 31/001; A01G 1/001

(57) ABSTRACT

A method for growing and harvesting produce using an aquaponics system. The system includes a tank, at least one support structure, and at least one harvesting device having at least one hole to accommodate plant roots.

### CROSS-REFERENCE TO RELATED APPLICATIONS

The present Application claims the benefit of U.S. Provisional Patent Application No. 62/238,854 to Shelton, entitled “Method and Apparatus for Aquaponic Farming”, and filed on Oct. 8, 2015, which is hereby incorporated by reference in its entirety.

### FIELD OF THE DISCLOSURE

The present Application relates generally to systems, methods, and devices for growing produce, and more specifically to systems, methods and devices used in aquaponics and hydroponics.

### BACKGROUND OF THE DISCLOSURE

Aquaponics, or the process of combining hydroponic and aquaculture, has been used as an agricultural discipline for centuries. In conventional aquaponics systems, water from an aquaculture subsystem comprising aquatic animals kept in tanks is fed to a conversion subsystem where the ammonia-rich wastes are broken down by bacteria into nitrites and nitrates. The nitrate-rich water is then fed to a hydroponic system (plants grown in water), where the plants use these yields as nutrients as a fertilizer. The water then recirculates back to the aquaculture system, thus starting the cycle again.

Historically, a drawback to aquaponics is that it was considered an inefficient means of production that required a large amount of input energy and capital to invest in the system setup. In particular, conventional harvesting techniques in aquaponics and hydroponic generally can be labor-intensive and damaging to the plants, and can reduce the efficiency of the production of produce.

### SUMMARY OF THE DISCLOSURE

The present disclosure relates to methods, systems, and devices for growing and harvesting produce which may employ a plurality of techniques used in the field of aquaponics and/or hydroponics. The disclosed production system may comprise one or more conventional components of aquaponics systems, described above, including: an aquaculture subsystem, a conversion subsystem, and a hydroponic subsystem.

Referring to the present disclosure, in some embodiments, a production system includes a cultivation tank at least partially filled with hydroponics fluid, and a support structure including at least one support structure hole. The at least one support structure hole receives roots of produce to allow the roots to extend into the hydroponics fluid. The system may further include a harvesting device positioned above the support structure, and separable from the support structure. The harvesting device can include at least one harvesting device hole positioned above the at least one support structure hole to permit roots of the produce to extend through the harvesting device.

In other embodiments, a method for growing produce using an hydroponics system, may include providing an hydroponics system including a cultivation tank at least partially filled with hydroponics fluid, a support structure supported by the hydroponics fluid, and a harvesting device. The method may also comprise aligning a hole of a support structure with a corresponding hole of a harvesting device, and supporting the harvesting device on the support structure such that the corresponding hole of the harvesting device is aligned with the hole of the support structure. The method may further include transplanting produce in the corresponding hole of a harvesting device, and harvesting the produce by lifting the harvesting device from the support structure, such that the produce is removed from support structure.

Additional features of the present disclosure will become apparent to those skilled in the art upon consideration of the following detailed description of the illustrative embodiment exemplifying the best mode of carrying out the disclosure as presently perceived.

### BRIEF DESCRIPTION OF THE DRAWINGS

The aforementioned aspects and many of the intended features of this disclosure will grow to be appreciated at a greater level once references to the following accompanying illustrations are expounded upon.

FIG. 1 is a perspective view of a building housing an embodiment of an aquaponics system;

FIG. 2 depicts a flow chart of an aquaponics system;

FIG. 3A is a perspective view of an embodiment of a maturation subsystem facilitating the growth and maturation of sprouting produce;

FIG. 3B is a perspective view of an embodiment of a hydroponic subsystem of an aquaponics system with growing produce;

FIG. 4 is a top view of an embodiment of a hydroponic subsystem of an aquaponics system comprising a plurality of supporting structures and harvesting devices;

FIG. 5 is a perspective view of one embodiment of a harvesting device, showing the harvesting device suspended above a hydroponic subsystem and supporting produce; and

FIG. 6 is a bottom view of the harvesting device of FIG. 3 suspended in the air, showing exposed the roots of the harvested produce.

Equivalent reference components point to corresponding parts throughout the several views. Unless otherwise indicated, the components shown in the drawings are proportional to each other. Wherein, the illustrations depicted are manifestations of the disclosure, and such illustrations shall in no way be interpreted as limiting the scope of the disclosure.

### DETAILED DESCRIPTION OF THE DRAWINGS

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

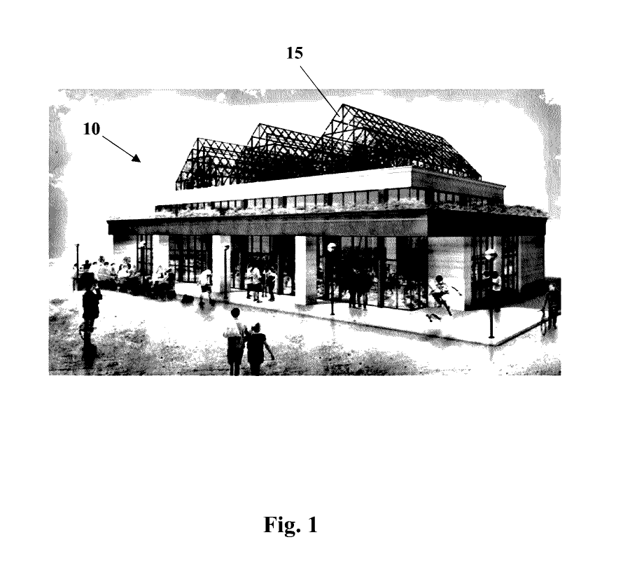

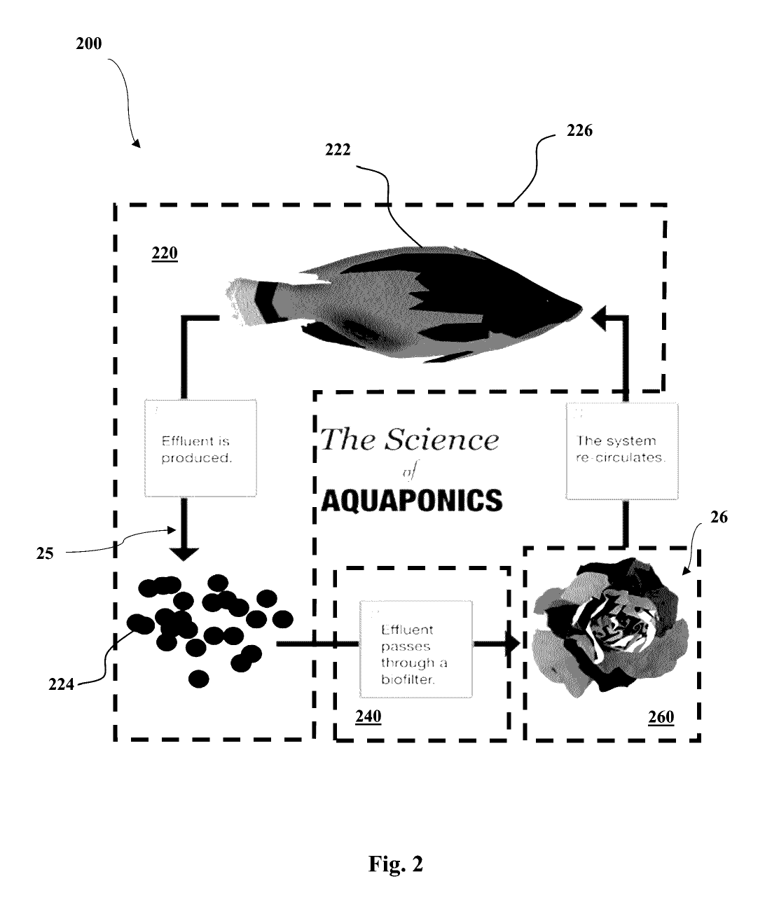

Referring to FIG. 1, a building 10 is shown that houses an aquaponics system 200 (see FIG. 2). Building 10 comprises a plurality of greenhouse panels 15 configured to let light inside of building 10 while providing some protection from the surrounding environment, weather, etc.

Referring now to FIG. 2, a flow chart is shown of one embodiment of aquaponics system 200. Aquaponics system 200 comprises a plurality of subsystems, such as aquaculture subsystem 220, biofilter subsystem 240, and hydroponic subsystem 260. In other embodiments, aquaponics system 200 may comprise fewer or more subsystems or subcomponents.

Referring specifically to aquaponics system 200 shown in FIG. 2, aquaculture subsystem 220 may comprise a tank of water or other fluid 226 and living aquatic creatures or matter 222, such as fish, snails, mollusks, or crustaceans, capable of producing effluent 224 (e.g., fecal matter) or other organic wastes to be fed to biofilter subsystem 240. For the purposes of this disclosure, biofilter subsystem 240 may also be referred to as a “filter,” and tank of water 226 of aquaculture subsystem 220 may be referred to as a “nutrient production tank.” Aquatic creatures 222 may be provided with any appropriate food matter to sustain aquatic creatures 222 and allow them to produce effluent 224. Effluent-rich water 25 from aquaculture subsystem 220 may then be fed to biofilter subsystem 240, where bacteria or other materials are capable of converting the toxic ammonia in effluent-rich water 25 into nitrates and nitrites. After passing through biofilter subsystem 240, water 25, now rich in nitrates and nitrites, may then pass to hydroponic subsystem 260, where the nitrates, nitrites, and other nutrients in water 25 can be used to provide nutrients to produce or other plant life 26.

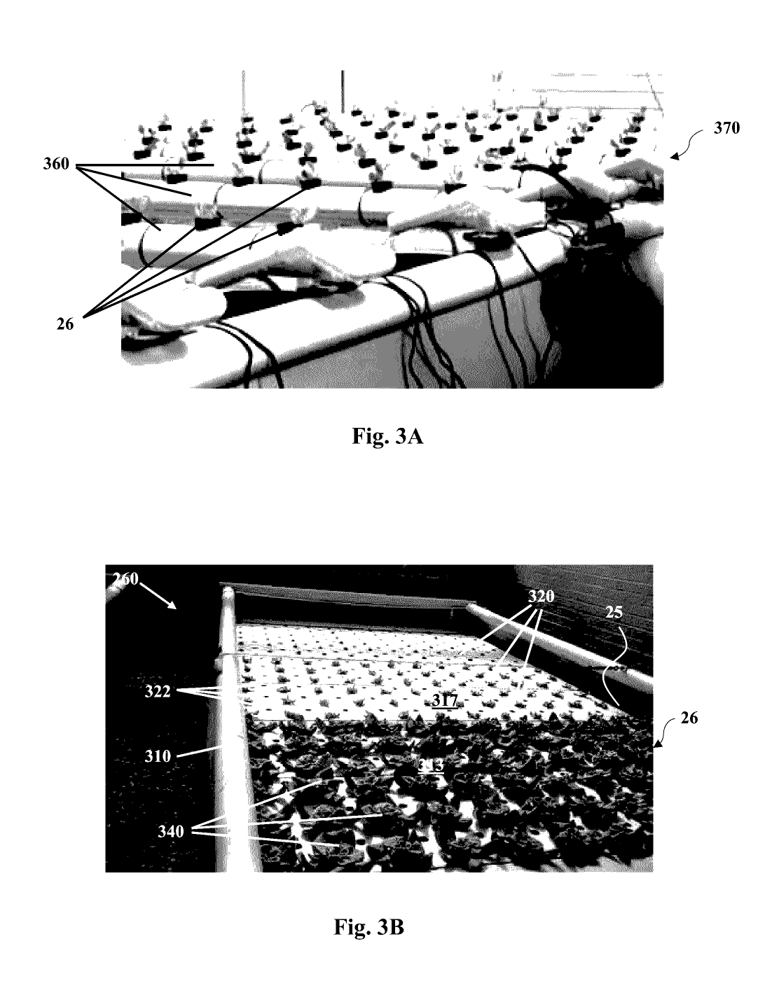

As will become more apparent in FIGS. 3A-6, in some embodiments, aquaponics system 200 can comprise a maturation subsystem 370 in addition to biofilter subsystem 240 and hydroponic subsystem 260. Maturation subsystem 370 may be configured to develop produce 26 from an initial growth or sprout stage to a transplantation stage or point that produce 26 can be transplanted to hydroponic subsystem 260. Additionally, hydroponic subsystem 260 may allow produce 26 which is transplanted to hydroponic subsystem 260 to grow to the point that it can be harvested. Such a configuration may allow produce 26 to grow without the use of a soil substrate. Although, the components of the present disclosure could also be used to grow produce 26 with a soil substrate.

FIG. 3A shows maturation subsystem 370, according to one embodiment. In some embodiments, maturation subsystem 370 is configured to allow newly sprouted produce 26 to grow from a sprout stage to a second growth stage in which the produce 26 can be transplanted to hydroponic subsystem 260. Maturation subsystem 370 may be comprised of a plurality of channels 360 configured to deliver effluent rich water 25 to produce 26. Referring generally to FIGS. 3A to FIG. 6, while produce 26 is in maturation subsystem 370, root systems 350 of each unit of produce 26 may grow to the point that produce 26 can be transplanted into hydroponic subsystem 260 with root systems 350 in communication with effluent rich water 25 of hydroponic subsystem 260.

Referring to FIG. 3B, one embodiment of hydroponic subsystem 260 of aquaponics system 200 is shown. Hydroponics subsystem 260 comprises a water tank 310, and a plurality of support structures 320 which are floating atop water 25 contained within water tank 310. Water tank 310 may also be referred to as a “hydroponics tank,” or a “cultivation tank.” In one embodiment, water tank 310 may be approximately eight feet long, four feet wide, and one foot deep, while support structures 320 may be may be sized compatibly with water tank 310. For example, in some embodiments, support structure 320 may have a thickness of one inch, a length of four feet, and a width of two feet, which allows four support structures 320 to run lengthwise spanning the width of water tank 310. In other embodiments, support structure 320 may be sized to allow fewer or more support structures 320 to run lengthwise spanning the width of water tank 310 and water tank 310 may be larger or smaller. Support structures 320 may be comprised of any suitable material, such as polystyrene foam, polyurethane, foam rubber, wood, or metal. While support structures 320 in the depicted embodiment are floating, support structures 320 may be suspended atop or above water 25 by other means, such as trusses or support legs supported by water tank 310 in a way that suspends support structure 320 inside water tank 310. In other embodiments, support structures 320 may be suspended above or outside of water tank 310.

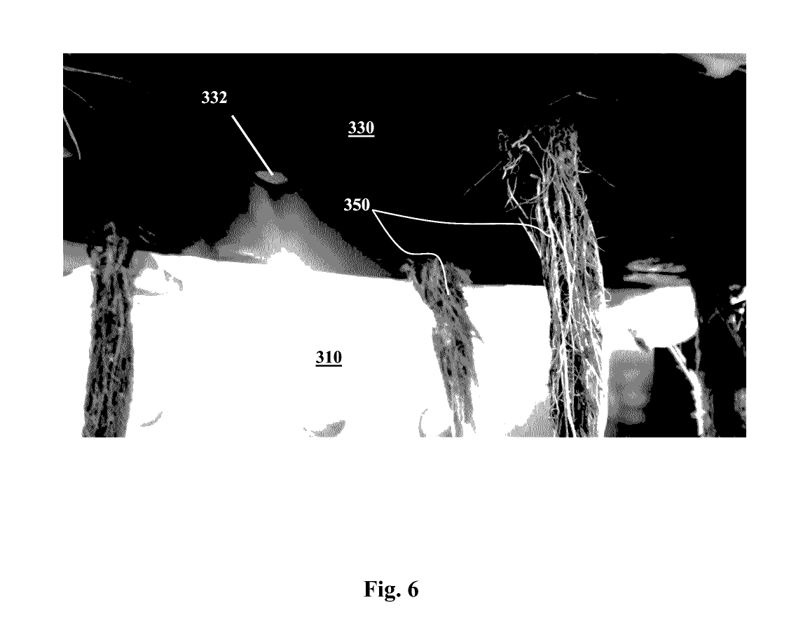

Referring still to FIG. 3B, support structures 320 are shown supporting a plurality of produce units 26 at various stages of growth. Support structures 320 suspending produce 26 allow the leafy growth of produce 26 to be exposed to light and air while allowing the root systems 350 of produce 26 to descend into water 25 below and, because water 25 is rich in nitrates and nitrites, water 25 facilitates growth of produce 26. Root systems 350 (see FIGS. 5 and 6) of produce 26 descend into water 25 through one or more holes 322 in support structures 320. Holes 322 may be sized or configured to allow a substantial portion of root systems 350 of produce 26 to pass through holes 322 into water 25 below, while retaining at least a portion of produce 26 above support structure 320 to be exposed to light and air. In some embodiments, holes 322 and holes 332 may be substantially circular, and may have diameters of between about 0.3 inches to about 3 inches.

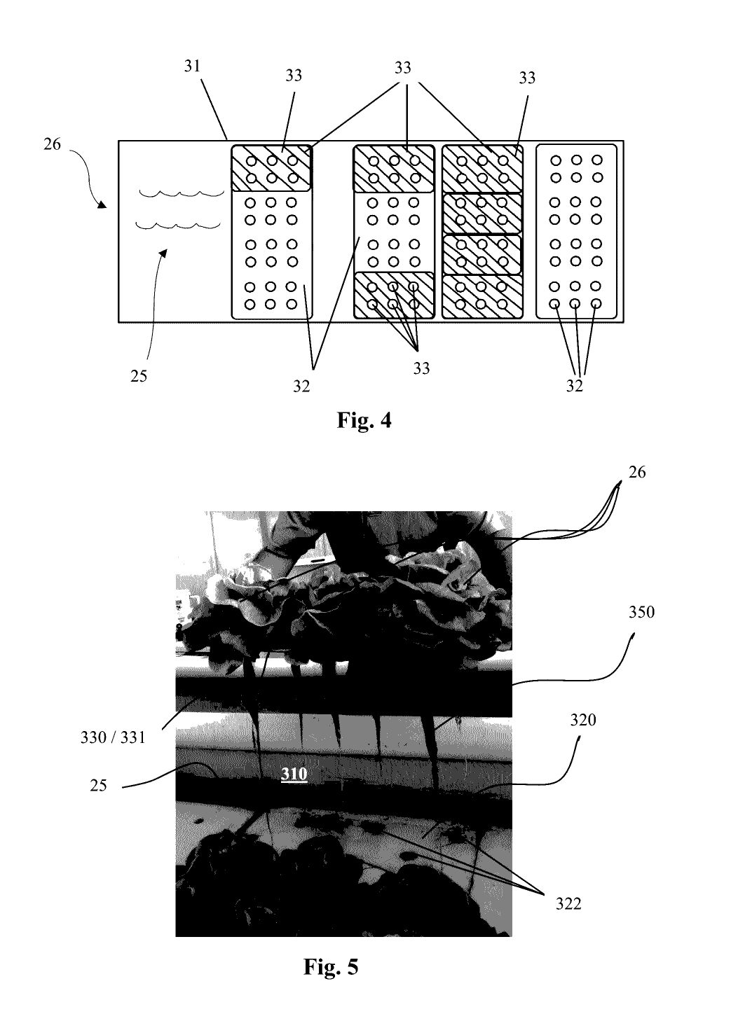

As shown in FIGS. 3B, 5 and 6, holes 322 may be arranged in a pattern of rows, and holes 322 in each row are equally spaced from one another in a linear fashion. Each row may be arranged parallel to and offset from neighboring rows by half the distance between holes 322 in each row. In some embodiments, holes 332 of are arranged to match and/or align with holes 322 of support structures 322. In other words, holes 322 of FIGS. 3B, 5 and 6 may be arranged in a rhombic lattice. In other embodiments, such as the embodiment of FIG. 4, holes 322 may be arranged such that each row of holes 322 is aligned in a rectangular lattice. Alternatively, holes 322 may be arranged in any pattern.

Additionally, support structures 320 are shown in FIG. 3B supporting a plurality of growing produce 26 at various stages of growth. In some embodiments, the position of support structures 320 within tank 310 may indicate the relative stage of growth and may indicate whether individual units of produce 26 are ready to harvest. Thus, as shown in FIG. 3B, produce 26 near the front of tank 310, illustratively shown at approximately the bottom of FIG. 3B, may be more mature, and thus ready for harvesting sooner, than produce 26 at the back of tank 310, illustratively shown at approximately the top of FIG. 3B. This order may be maintained by removing one or more of support structures 320 when corresponding units of produce 26 are harvested or removed from the one or more of support structures 320. Then, remaining support structures 320 supporting growing produce 26 can be shifted toward the front of tank 310, and support structures 320 which were removed can be replaced into tank 310 near the back of tank 310 (illustratively at approximately the top of FIG. 3B, for example).

In another embodiment of aquaponics system 200, shifting growing produce 26 with support structures 320 from a first portion 313 of hydroponics subsystem 260 to a second portion 317 of hydroponics subsystem 260 may benefit the growing produce 26. The water and other conditions in the first portion 313 of hydroponics subsystem 260 may vary from the water and other conditions in the second portion 317 of hydroponics subsystem 260. For example, the water conditions that may vary between the first 313 and second 317 portions include, but are not limited to, pH level, temperature, nitrate and nitrite levels, and oxygen level. Further, this embodiment of hydroponics subsystem 260 should not be limited to only a first portion and a second portion. Rather, as shown in FIG. 3, there may be three stages of growth in hydroponic subsystem 260 which correspond to three portions of hydroponic subsystem 260. Thus, depending on the various stages of growth of produce 26, hydroponics subsystem 260 may have a three or more portions.

Hydroponic subsystem 260 is also shown in FIG. 4. As shown in FIG. 4, hydroponic subsystem 260 comprises a plurality of harvesting devices or panels 330 positioned on top of support structures 320. As also shown in FIG. 6, each harvesting device 330 comprises one or more panel(s) 331 with a thickness between about 0.1 inches to about 0.5 inches. Each panel 331 of harvesting device 330 may have a plurality of holes 332 in a pattern which may align with holes 322 of support structures 320 below.

One or more harvesting devices 330 may be placed atop support structures 320 before or during any time of the growth of produce 26, but preferably before the leafy growth of produce 26 is wider than holes 332 in panel 331. Panels 331 can be positioned directly on support structures 320 so that holes 332 align with holes 322 to allow roots 350 (or other portions) of produce 26 to extend through holes 332, 322. Each of harvesting devices 330 has a top surface area, which can be less than or equal to a top surface area of support structures 320. In the embodiment of FIG. 4, the top surface area of support structures 320 is about four times the top surface area of harvesting devices 330.

In other embodiments, support structure 320 may cover smaller or larger portion of the surface of water 25 than the embodiment of FIG. 4. Similarly, harvesting devices 330 may cover a smaller or larger portion of underlying support structures 320 than the embodiment depicted in FIG. 4.

FIG. 5 is a perspective view of one embodiment of harvesting device 330 of FIG. 4. The depicted embodiment of harvesting device 330 comprises a thin, flat, rectangular corrugated polypropylene plastic panel or platform comprising a plurality of holes 332 configured to permit root systems 350 of one or more units of produce 26 to hang down into water 25 contained in water tank 310 of hydroponic subsystem 260. In other embodiments, harvesting device 330 may be comprised of different materials (e.g., other polymeric materials, ceramics, wood, or any other suitable material) and may have different configurations with varying cross-sections. Harvesting device 330 may be sized compatibly with support structures 320. For example, panels 331 of harvesting device 330 may be two feet long by one foot wide and ⅛ inches thick, allowing four panels of harvesting device 330 to run lengthwise along the width of one support structure 320. According to other embodiments, panel 331 may have other dimensions. According to the present disclosure, tank 310 is about four times wider than panel 330 and tank 310 is about four times longer than panel 330. Similarly, support structure 320 is about four times wider than panel 331 and about the same width. According to other embodiments, the tank-to-panel width ratio may be smaller or larger than four (ex. 1, 2, 3, 4, 5, 6, 7 . . . 50) and the tank-to-panel length ration may be smaller or larger than four (ex. 1, 2, 3, 4, 5, 6, 7 . . . 50). Similarly, the support structure-to-panel width ratio may be smaller or larger than four (ex. 0.25, .5, .75, 1, 2, 3, 4, 5, 6, 7 . . . 50) and the support structure-to-panel length ratio may be smaller or larger than one (ex. 0.25, 0.5, 0.75, 1.5, 2, 3, 4, 5, 6, 7 . . . 50).

FIG. 5 also depicts support structure 320 configured to support harvesting device 330 and produce 26. In the embodiment of FIG. 5, support structure 320 comprises a foam platform that floats atop water 25 in water tank 310. Support structure 320 further comprises a plurality of holes 322 that allow root systems 350 of produce 26 to contact water 25 in water tank 310.

FIG. 6 is a bottom view of harvesting device 330 of FIG. 5 after harvesting device 330 has been lifted to remove fully mature or ripe produce 26 from hydroponic subsystem 260. When produce 26 is mature and ready to harvest, a user may grip and lift one of harvesting devices 330 to extract produce 26 from hydroponic subsystem 260 without directly contacting or otherwise manipulating produce 26 or support structure 220 which remain in water tank 310. In some embodiments, harvesting devices 330 may be configured to be distributed, along with produce 26, to one or more customers via a truck or other mode of transportation. In preparation for distribution to customers, root system 350 of produce 26 may be removed immediately after harvesting, or root system 350 may be left attached for a customer to remove. In this way, harvesting devices 330 may serve an additional purpose of facilitating packing and/or delivery.

Alternatively, harvesting device 330 may also be configured for re-use after produce 26 is harvested from hydroponic subsystem 260. For example, once harvesting device 330 is used to harvest produce 26, produce 26 may be removed from harvesting device 330 and prepared for delivery or distribution to a customer. As part of the preparation of produce 26, root system 350 may be removed from produce 26 immediately after harvesting. Harvesting device 330 may then be cleaned and repositioned in hydroponic subsystem 260 to facilitate growth and harvesting of more produce 26.

In other embodiments, a harvesting device (such as harvesting device 330) may further comprise a chemical treatment configured to inhibit growth or accumulation of bacteria or microbial contaminants. Anti-bacterial and anti-microbial treatments may further increase the functionality of harvesting device 330 as a means of delivery or packaging for a customer. Because of the tendency of bacteria to accumulate in an aquaponics system where significant amounts of bacteria are produced and used, inhibiting the growth or accumulation of the bacteria on harvesting device 330 and above roots 350 may reduce the work required to clean produce 26 of bacteria before handling, distributing, or consuming produce 26.

It will be understood by one of skill in the art that at least some components of the aquaponics and hydroponic systems disclosed herein may also be used in other agricultural settings, such as traditional soil-based agriculture, to provide for more efficient means of harvesting produce 26. Furthermore, the various embodiments of harvesting device 330 described in the present disclosure are not intended to limit the scope of the device to the named uses and features. For example, it will be clear to one of skill in the art that harvesting device 330 disclosed herein may alternately have a circular, or elliptical shape, instead of the rectangular shape depicted in FIGS. 3 and 4. In other embodiments, harvesting device 330 may have a greater, or lesser thickness than the embodiment of FIGS. 3 and 4 to meet the needs of the desired use. In other embodiments, the relative dimensions and proportions of water tank 310, support structure 320, and harvesting device 330 may be modified to accommodate different applications or settings. In yet other embodiments, platform may be comprised of materials such as wood, rubber, foam, wood pulp, glass, or metal. Further modifications or substitutions implemented to tailor the harvesting device to a particular use may also be within this disclosure.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practices in the art to which this disclosure pertains.

1. A system for harvesting produce comprising:
a cultivation tank at least partially filled with hydroponics fluid;
a support structure including at least one support structure hole configured to receive roots of produce to allow the roots to extend into the hydroponics fluid; and
a harvesting device positioned adjacent the support structure, the harvesting device including at least one harvesting device hole positioned adjacent the at least one support structure hole to permit roots of the produce to extend through the harvesting device.

2. The system of claim 1, wherein the support structure includes a plurality of support structure holes, the support structure holes are arranged in rows, each row includes a plurality of equally-spaced support structure holes in a linear arrangement, and each row is arranged parallel to and offset from adjacent rows in a rhombic lattice pattern.

3. The system of claim 2, wherein the harvesting device includes a plurality of harvesting device holes defining a pattern matching a pattern defined by the support structure holes, such that the harvesting device holes align with at least a portion of the support structure holes when the harvesting device is placed over the support structure.

4. The system of claim 1, wherein at least a portion of the support structure holes are circular and have a diameter between about 0.3 inches and about 3 inches.

5. The system of claim 4, wherein the harvesting device holes are circular and have a diameter between about 0.3 inches and about 3 inches.

6. The system of claim 1, wherein the support structure floats on the hydroponics fluid. The system of claim 1, further including:
a plurality of support structures, each of the plurality of support structures comprising one or more support structure holes configured to receive roots of produce to allow the roots to extend into the hydroponics fluid; and
a plurality of harvesting devices, each of the plurality of harvesting devices are positioned adjacent to a corresponding one of the plurality support structures, each of the plurality of harvesting devices including at least one harvesting device hole positioned adjacent a corresponding one of the support structure holes to permit roots of the produce to extend through the harvesting device.

8. The system of claim 1, wherein the support structure has a first top surface area and the harvesting device has a second top surface area and the first top surface area is at least twice as large as the second top surface area.

9. The system of claim 1, wherein the harvesting device further comprises a flat panel having a thickness between about 0.1 inches to about 0.5 inches.

10. The system of claim 1 further comprising:
a nutrient production tank in fluid communication with the cultivation tank, the nutrient production tank being at least partially filled with the hydroponics fluid and configured to introduce nutrients into the hydroponics fluid; and
a filter in fluid communication with the nutrient production tank and configured to remove one or more substances from the hydroponics fluid.

11. A method for growing produce using a hydroponics system, comprising the steps of:
providing a hydroponics system including a cultivation tank at least partially filled with hydroponics fluid, a support structure, and a harvesting device, aligning a hole of a support structure with a corresponding hole of a harvesting device;
supporting the harvesting device on the support structure such that the corresponding hole of the harvesting device is aligned with the hole of the support structure;
transplanting produce in the corresponding hole of a harvesting device; and
harvesting the produce by removing the harvesting device from the support structure, such that the produce is removed from support structure.

12. The method of claim 12, wherein the step of harvesting the produce includes removing a first portion of the produce simultaneously from both the support structure and the harvesting device.

13. The method of claim 12, further comprising moving the support structure from a first portion of the cultivation tank to a second portion of the cultivation tank.

14. The method of claim 12, further comprising providing a maturation subsystem of the hydroponics system; and growing a sprout of the produce in the maturation subsystem before transplanting the sprout to a corresponding hole of a harvesting device.

15. The method of claim 12 further comprising the step of measuring the hydroponics fluid for at least one of a nitrogen content, a pH level, or a temperature.

16. The method of claim 12, further comprising removing a root system from the produce while the harvesting device supports the produce.

17. The method of claim 12, further comprising packaging the produce while the produce is supported by the harvesting device.

18. The method of claim 12, further comprising treating the harvesting device after removal of the produce to inhibit growth of contaminants.
